(19) United States
(12) Patent Application Publication
(10) Pub. No.: US 2016/0371941 A1
(43) Pub. Date: Dec. 22, 2016

(54) PHYSICAL INFORMATION MEASURING DEVICE, PHYSICAL INFORMATION MEASURING SYSTEM, AND DATA PROCESSING METHOD

(71) Applicant: Seiko Epson Corporation, Tokyo (JP)

(72) Inventor: Shintaro Nagasaki, Hara-mura (JP)

(21) Appl. No.: 15/174,841

(22) Filed: Jun. 6, 2016

(30) Foreign Application Priority Data
Jun. 16, 2015 (JP) 2015-120871

(51) Int. Cl. G08B 5/22; G06T 11/20; G06F 3/14

(52) U.S. Cl. CPC G08B 5/225; G06F 3/14; G06T 11/206

(57) ABSTRACT

A physical information measuring device includes: a measuring unit which measures physical information about a body; a measurement data generator which generates measurement data on the basis of the physical information; a display data generator which generates display data to be displayed at an information terminal; a wireless communication device which transmits the measurement data and the display data to the information terminal; and a processor which performs control to transmit the display data preferentially over the measurement data.

### CROSS-REFERENCES TO RELATED APPLICATIONS

This application claims priority to Japanese Patent Application No. 2015-120871, filed Jun. 16, 2015, the entirety of which is herein incorporated by reference.

### BACKGROUND

1. Technical Field

The present invention relates to a physical information measuring device, a physical information measuring system, and a data processing method.

2. Related Art

According to the related art, as a measuring system used for exercise management and health care for the user, a device which is mounted on a part of the user's body to measure pulse rate and body motion is known, for example, as disclosed in JP-A-2010-141469. This device measures information about the user's pulse rate and information about exercise, and transmits the measured information to a host via wireless communication. The host, having received the information from the device, carries out detailed analysis based on the received information and processes the result of the analysis.

Recently, near field communication is employed as a communication method suitable for this system. Specifically, Bluetooth (trademark registered) Low Energy (BLE), infrared communication, and ultra-wideband (UWB) are known. By employing BLE communication, it is possible to connect the device and the host simply and with less electricity. Also, unlike the traditional Bluetooth profile, profiles specializing in specific use cases (exercise, health, host-linked, and the like) are formulated under the BLE standard. Therefore, if the formulated standard profiles are supported, connectivity between different devices is guaranteed.

In the case of the device which is mounted on a part of the user's body to measure pulse rate and body motion, there is no problem with low-speed wireless communication if communication is constantly available. However, there are cases where the user is in a poor communication environment for a long time, or where measuring needs to be carried out at a high frequency in order to accurately measure the user's physical condition, the condition of disease, or the like. In such cases, it takes a long time to complete communication if the communication speed is low. Therefore, when the result of the measuring is displayed on the device side so as to allow an expert such as a doctor, or the user, to visually recognize the result, the host cannot display sufficient information until the reception of a large volume of measured data is completed, resulting in poor usability.

### SUMMARY

An advantage of some aspects of the invention is that the result of measuring physical information can be swiftly displayed.

The invention can be implemented as the following forms or application examples.

### APPLICATION EXAMPLE 1

A physical information measuring device according to this application includes: a measuring unit which measures physical information about a body; a measurement data generator which generates measurement data on the basis of the physical information; a display data generator which generates display data to be displayed at an external device, on the basis of the measurement data; a transmitter which transmits the measurement data and the display data to the external device; and a controller which performs control to transmit the display data preferentially over the measurement data.

According to this configuration, the display data is generated on the basis of the measurement data, and the generated display data is transmitted to the external device preferentially over the measurement data. Therefore, the external device can receive the display data and perform display processing without waiting to receive the measurement data. Thus, the measured physical information can be swiftly displayed and this enables improved usability.

### APPLICATION EXAMPLE 2

In the physical information measuring device according to the application example, it is preferable that the display data is made up of time information and the measurement data corresponding to the time information.

According to this configuration, the measurement data can be swiftly displayed, corresponding to the time information.

### APPLICATION EXAMPLE 3

In the physical information measuring device according to the application example, it is preferable that the measurement data includes a pulse rate and an action trend value indicating an action of the body.

According to this configuration, the pulse rate and the action trend can be displayed.

### APPLICATION EXAMPLE 4

In the physical information measuring device according to the application example, it is preferable that the display data generator generates the display data by calculating an average value or a representative value of the measurement data corresponding to a plurality of periods.

According to this configuration, the data volume of the display data can be compressed.

### APPLICATION EXAMPLE 5

In the physical information measuring device according to the application example, it is preferable that the controller causes the display data to be transmitted to the external device and causes the measurement data to be transmitted to the external device in the background after the transmission of the display data is finished.

According to this configuration, the measurement data is transmitted in the background after the transmission of the display data is finished. Therefore, the measurement data can be transmitted efficiently.

### APPLICATION EXAMPLE 6

It is preferable that the physical information measuring device according to the application example includes a first memory which stores the measurement data, and a second memory which stores the display data.

According to this configuration, the measurement data and the display data can be stored in the different memories.

### APPLICATION EXAMPLE 7

In the physical information measuring device according to the application example, it is preferable that the measuring unit includes a pulse wave sensor and an acceleration sensor.

According to this configuration, the physical information measuring device can measure information of pulse waves and acceleration.

### APPLICATION EXAMPLE 8

A physical information measuring system according to this application example is a physical information measuring system in which a measuring device and an information processing device are connected in such a way as to be able to communicate with each other. The measuring device includes: a measuring unit which measures physical information about a body; a measurement data generator which generates measurement data on the basis of the physical information; a display data generator which generates display data to be displayed at the information processing device, on the basis of the measurement data; a transmitter which transmits the measurement data and the display data to the information processing device; and a controller which performs control to transmit the display data preferentially over the measurement data. The information processing device includes: a receiver which receives the measurement data and the display data; and a display controller which causes a display to display a graph image generated on the basis of the display data that is received.

According to this configuration, the display data is generated on the basis of the measurement data, and the generated display data is transmitted to the information processing device preferentially over the measurement data. Therefore, the information processing device can receive the display data and perform display processing without waiting to receive the measurement data. Thus, the measured physical information can be swiftly displayed and this enables improved usability.

### APPLICATION EXAMPLE 9

In the physical information measuring system according to the application example, it is preferable that the display controller performs processing of updating the graph image on the basis of the measurement data when the reception of the measurement data is completed.

According to this configuration, the graph image can be updated when the reception of the measurement data is completed.

### APPLICATION EXAMPLE 10

In the physical information measuring system according to the application example, the display controller may change a display form of at least a part of the graph image when the reception of the measurement data is completed.

### APPLICATION EXAMPLE 11

In the physical information measuring system according to the application example, as the change in the display form, a display density in at least a part of the graph image may be changed.

### APPLICATION EXAMPLE 12

In the physical information measuring system according to the application example, the information processing device may include an operation device which accepts instruction information to the graph image, and the display controller may perform change processing on the graph image on the basis of a signal from the operation device.

### APPLICATION EXAMPLE 13

In the physical information measuring system according to the application example, the change processing on the graph image may include change processing on a display period and type change processing on the measurement data to be displayed.

### APPLICATION EXAMPLE 14

In the physical information measuring system according to the application example, the display controller may generate an icon indicating a receiving status of the measurement data and may cause the display to display the icon.

According to this configuration, the user can be notified of the receiving status of the measurement data.

### APPLICATION EXAMPLE 15

In the physical information measuring system according to the application example, the information processing device may include an analyzer which analyzes the measurement data, and the analyzer may generate analysis data including at least one of depth of sleep, variation in heart rate, and physical strength index, on the basis of the measurement data.

### APPLICATION EXAMPLE 16

In the physical information measuring system according to the application example, it is preferable that the display controller causes the display to display the analysis data in association with the graph image when the analysis data is acquired.

According to this configuration, the result of analysis can be displayed in association with the detailed graph image.

### APPLICATION EXAMPLE 17

In the physical information measuring system according to the application example, it is preferable that the information processing device includes a memory which stores the measurement data, the display data, and the analysis data.

According to this configuration, the measurement data and the display data can be saved in the information processing device.

### APPLICATION EXAMPLE 18

A data processing method according to this application example includes: measuring physical information about a body; generating measurement data on the basis of the physical information; generating display data to be displayed at an external device, on the basis of the measurement data; and transmitting the display data to the external device, and transmitting the measurement data after the transmission of the display data is finished.

According to this method, the display data is generated on the basis of the measurement data, and the generated display data is transmitted to the external device preferentially over the measurement data. Therefore, the external device can receive the display data and perform display processing without waiting to receive the measurement data. Thus, the measured physical information can be swiftly displayed and this enables improved usability.

### BRIEF DESCRIPTION OF THE DRAWINGS

The invention will be described with reference to the accompanying drawings, wherein like numbers reference like elements.

FIG. 1 is a block diagram showing the configuration of a measuring system according to an embodiment of the invention.

FIG. 2 shows the database structure of display data.

FIG. 3 shows an example of a UI screen.

FIG. 4 shows an example of a simple graph image.

FIG. 5 is a flowchart showing the flow of processing in the measuring system.

### DESCRIPTION OF EXEMPLARY EMBODIMENTS

Hereinafter, an embodiment of the invention will be described with reference to the drawings.

### Embodiment

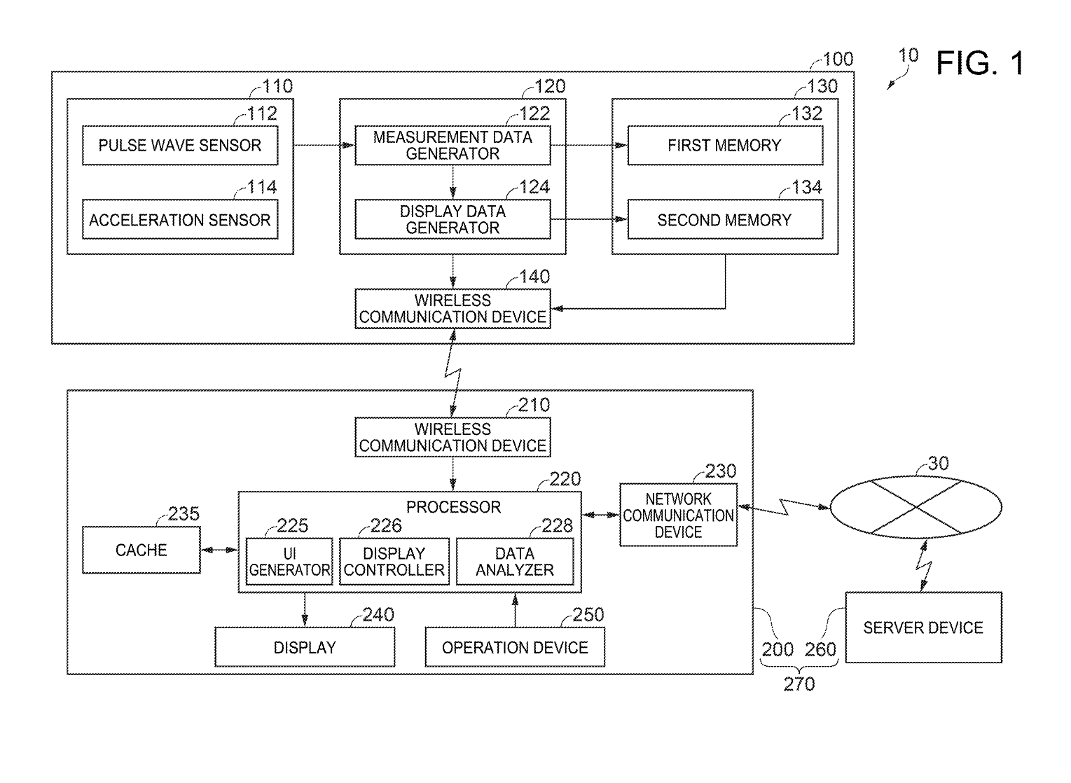

FIG. 1 is a block diagram showing the configuration of a measuring system 10 equivalent to a physical information measuring system. In this measuring system 10, a measuring device 100 and an information processing device 270 are connected together via near field communication, and the information processing device 270 has the function of processing useful information for health care on the basis of physical information measured by the measuring device 100. The measuring device 100 is equivalent to a physical information measuring device. As viewed from the measuring device 100, the information processing device 270 and a server device 260 are equivalent to external devices.

In the embodiment, a wireless communication device (transmitter) 140 and a wireless communication device (receiver) 210 carry out near field communication with each other. For this near field communication, BLE is employed, which is a communication method with a better power saving capability than the traditional short-range communication. As already known, under the BLE standard, the data transfer speed is low and the data transfer speed used in the measuring system 10 is approximately 2 kbps.

The communication method is not limited to BLE. For example, other near field communication methods such as Bluetooth (trademark registered), ultra-wideband (UWB), and infrared communication may also be employed.

In the embodiment, it is assumed that, as the information processing device 270, an information terminal 200 like a high-function mobile phone such as a smartphone, or a multi-function mobile terminal such as a tablet computer, is connected to the server device 260 via a network 30. However, this example is not limiting. For example, an integrated configuration in which the information terminal 200 has the data storage function of the server device 260 is also conceivable.

The information terminal 200 has, as its functional components, the wireless communication device 210, a processor 220, a network communication device 230, a cache 235, a display 240, and an operation device 250. In the embodiment, it is assumed that a touch panel in which the display 240 and the operation device 250 are integrated is employed.

The measuring device 100 is a device which can be mounted on the user's body and has an appearance like a wristwatch, for example. In this example, it is assumed that the measuring device 100 is mounted on a body part of the user such as an arm.

The measuring device 100 has, as its functional components, a measuring unit 110, a processor 120, a memory 130, and the wireless communication device 140.

First, each function of the measuring device 100 will be described.

The measuring unit 110 has a pulse wave sensor 112 which outputs a measurement signal (pulse wave signal) corresponding to a pulse, and an acceleration sensor 114 which outputs a measurement signal (acceleration signal) corresponding to acceleration. The measuring unit 110 may also have a motion sensor such as a tilt sensor, angular velocity sensor or gyro sensor, a temperature sensor, a barometric sensor, and a location sensor using GPS satellites, or the like.

The processor 120 processes the measurement signals outputted from the measuring unit 110. The processor 120 has a measurement data generator 122 and a display data generator 124 and is equivalent to a controller.

Each function of the processor 120 is implemented by organic collaboration between hardware resources including a CPU, a RAM and the like, none of which is shown, and various kinds of software stored in a ROM, a flash memory and the like.

The measurement data generator 122 performs various kinds of signal processing and statistical processing on the measurement signals and thus generates measurement data expressing details of physical information such as pulse rate, the number of steps taken, calories burned, and mental state, every predetermined period of time. In the embodiment, the measurement data is generated, for example, every 4 seconds.

As a method for calculating the number of steps taken from an acceleration signal, for example, the procedures disclosed in JP-A-2004-81745 can be employed. As a method for calculating the pulse rate from a pulse wave signal, for example, the procedures disclosed in JP-A-2012-232010 can be employed.

The processor 120 generates detail data including data for generating a detailed graph and history information, on the basis of the measurement data generated by the measurement data generator 122, and transmits the generated detail data to the information terminal 200 from the wireless communication device 140. The measurement data is also stored in a first memory 132 of the memory 130. The display data generator 124 can acquire the measurement data according to need.

The display data generator 124 acquires the measurement data generated by the measurement data generator 122, in conformity with a predetermined rule, and generates display data to be displayed at the information terminal 200 on the basis of the acquired measurement data. The display data generated by the display data generator 124 is transmitted to the information terminal 200 from the wireless communication device 140. Also, the display data is stored in a second memory 134 of the memory 130.

The display data generator 124 generates the display data by compressing some of the acquired measurement data on the basis of a predetermined rule and then processing the compressed measurement data.

In the embodiment, when the measuring device 100 is started up and enabled to communicate with the information terminal 200, the processor 120 first instructs the measurement data generator 122 to generate measurement data, and also instructs the display data generator 124 to generate display data and preferentially transmit the generated display data to the information terminal 200. Subsequently, after the display data is transmitted to the information terminal 200, the processor 120 generates detail data including uncompressed measurement data and gives an instruction to transmit the generated detail data to the information terminal 200. In this case, it is preferable that the transmission of the detail data is carried out in the background because it takes a long time.

Here, the preferential transmission of the display data over the measurement data includes: transmitting the measurement data after the transmission of the display data is completed; transmitting the measurement data after the lapse of a predetermined time following the start of the transmission of the display data; and starting the transmission of the display data first and then starting the transmission of the measurement data without waiting for the completion of the transmission of the display data.

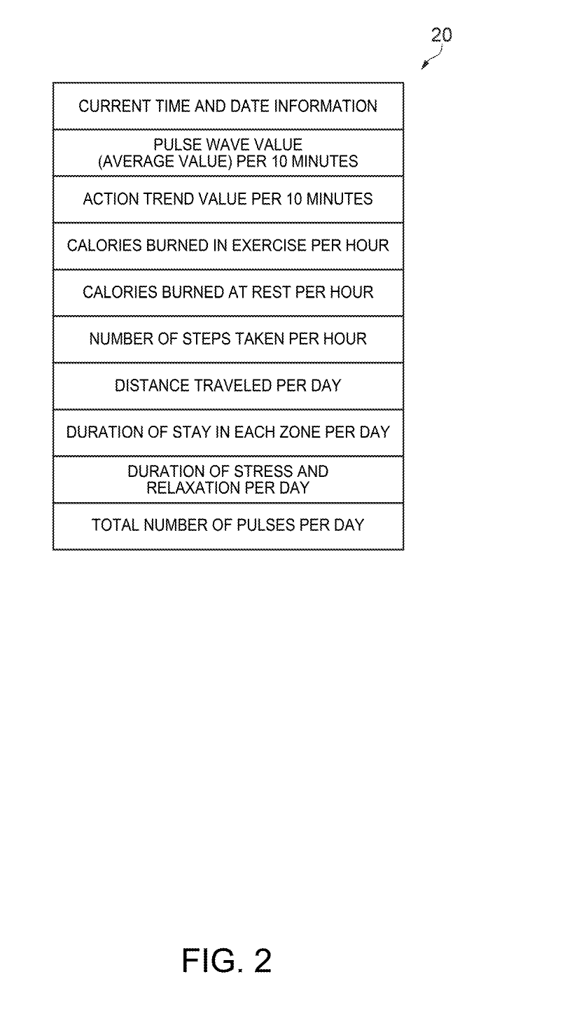

Next, the configuration of the display data will be described. FIG. 2 shows a database structure 20 of the display data generated by the display data generator 124 and transmitted to the information terminal 200.

In the database structure 20, the display data includes the information of “current time and date information”, “pulse wave value (average value) per 10 minutes”, “action trend value per 10 minutes”, “calories burned in exercise per hour”, “calories burned at rest per hour”, “number of steps taken per hour”, “distance travelled per day”, “duration of stay in each zone per day”, “duration of stress and relaxation per day”, and “total number of pulses per day”. This database structure 20 is an example. A database structure that does not include a part of these kinds of information is also conceivable.

The information of “pulse wave value (average value) per 10 minutes” and “action trend value per 10 minutes” is information for displaying approximate changes in the pulse wave value and the action trend with the lapse of time, on the display 240 of the information terminal 200.

The “pulse wave value (average value) per 10 minutes” and the “action trend value per 10 minutes” are compressed to represent values per 10 minutes. That is, while the measurement data of the pulse wave value is generated every 4 seconds, the average value calculated every 10 minutes is used as the display data, and the data volume is compressed to 1/150. The compression of data is not limited to the average value, and a representative value such as the median or a value that appears most frequently may be used as well.

The action trend value is information indicating the result of analyzing the action of the user every 10 minutes. The result of the analysis is associated with color information used to draw a graph.

Since the display data is information formed by compressing the measurement data, the volume of the display data transmitted from the measuring device 100 to the information terminal 200 can be approximately 95 percent less than in the case of transmitting the measurement data without compression. Therefore, even with BLE with a slow communication speed, the data can be transmitted without creating a sense of delay.

Back to FIG. 1, the first memory 132 of the memory 130 is assumed to be a flash memory, and the second memory 134 is assumed to be a RAM. Thus, a large volume of the measurement data corresponding to approximately 20 days can be stored in the first memory 132. In the second memory 134, the display data corresponding to approximately three days can be stored and can be read and written at high speeds.

Next, each function of the information terminal 200 will be described.

The processor 220 has a UI generator 225, a display controller 226, and a data analyzer 228.

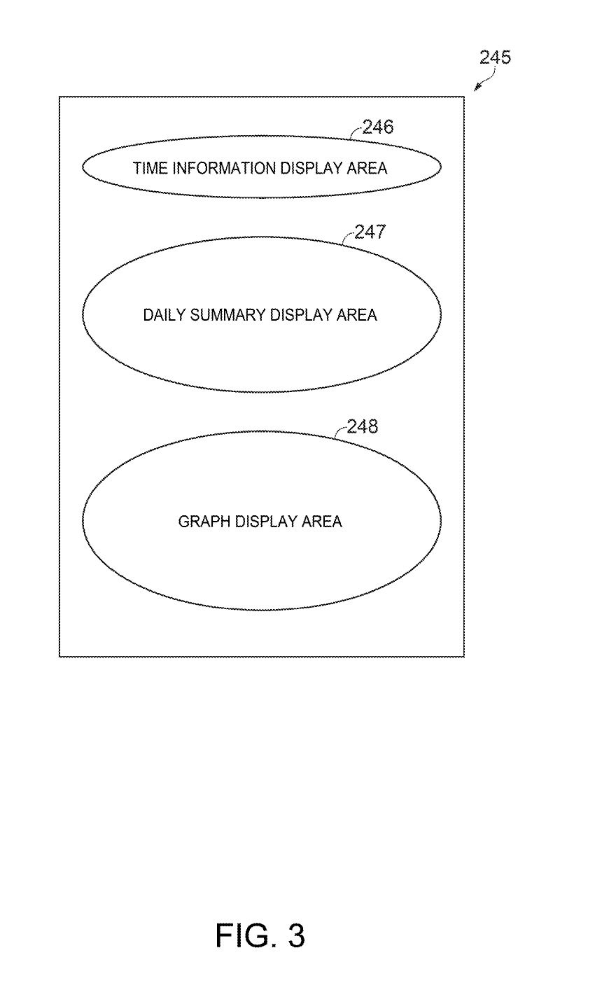

The UI generator 225 generates a user interface (UI) screen 245 (FIG. 3) to be displayed on the display 240, on the basis of the detail data and the display data sent from the measuring device 100. The display controller 226 causes the display 240 to display the generated UI screen 245.

The data analyzer 228 is equivalent to an analyzer. The data analyzer 228 analyzes the detail data sent from the measuring device 100 and thus generates analysis data. In the embodiment, the analysis data includes information that can only be acquired through the detail data, such as the depth of sleep indicating the states of REM sleep and non-REM sleep, variation in heart rate indicating the state of activity of autonomic nerves, physical strength index, and degree of fatigue, for example.

The analysis data generated by the data analyzer 228 may be called from the UI screen 245 displayed on the display 240 and thus displayed on the display 240. The detail data, the analysis data and the display data may be transmitted to the server device 260 and saved there for a predetermined period.

The cache 235 holds data of daily summaries and graphs on the UI screen 245 for approximately 6 months. If data cannot be received from the measuring device 100, the UI generator 225 generates the UI screen 245 on the basis of the data held in the cache 235.

The network communication device 230 is connected to the server device 260 connected via the network 30 by a wireless communication method. As this wireless communication method, for example, a method using a wireless LAN (local area network) or mobile phone channel can be employed.

FIG. 3 shows an example of the UI screen 245. This UI screen 245 has a time information display area 246, a daily summary display area 247, and a graph display area 248.

In the time information display area 246, information about date and time is displayed. In the daily summary display area 247, information such as calorie intake, the number of steps taken and hours of sleep per day, and mental balance, is displayed as a meter screen, for example.

In the graph display area 248, the state of variation with the lapse of time in the physical information including pulse rate and the number of steps taken is displayed as a graph image. The UI generator 225 generates a simple graph image on the basis of the display data, if the amount of information sent from the measuring device 100 is below a reference value. Meanwhile, the UI generator 225 generates a detailed graph image on the basis of information expressed by the detailed data, if the amount of information sent from the measuring device 100 is above the reference value.

In the embodiment, when the UI generator 225 generates a detailed graph image and its display in the graph display area 248 is completed, the UI generator 225 accepts a changes request from the user. For example, when the user operates the operation device 250 with fingers, the UI generator 225 can zoom in/out on a desired area in the detailed graph image or can display analysis data obtained as a result of analysis by the data analyzer 228 in association with the detailed graph image. As the display with such associated information, for example, the analysis data may be inserted in the detailed graph image, or an icon or the like indicating the receiving status of the detail data may be associated with a simple graph and displayed near this simple graph so as to allow the user to visually recognize the state of acquisition of the detail data.

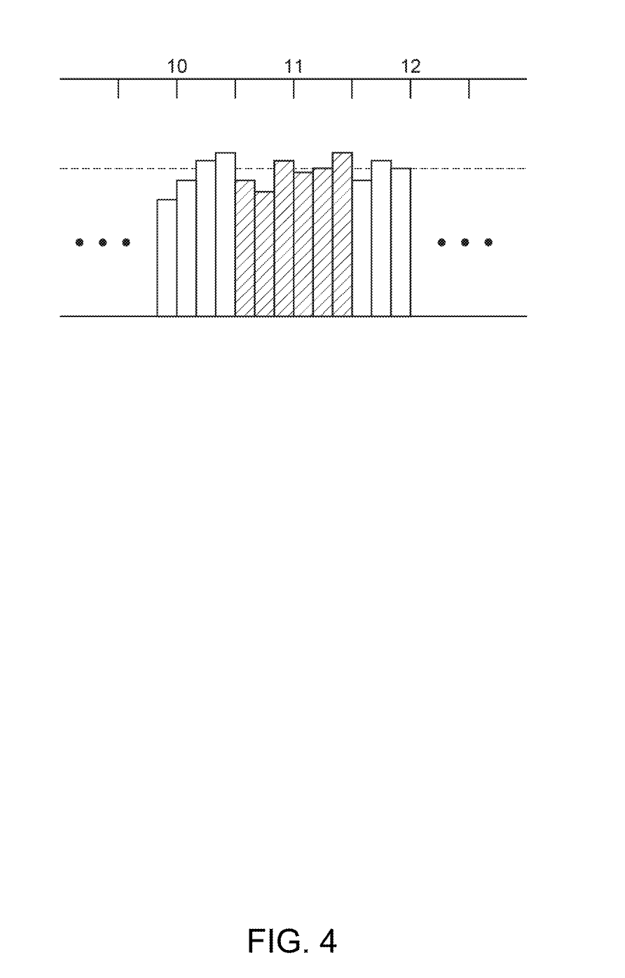

FIG. 4 shows an example of the simple graph image displayed in the graph display area 248. In this graph, time transition is taken in the horizontal direction, and the average value of pulse rate per 10 minutes is shown as a bar chart in the vertical direction. Also, the display pattern of the bar indicates the action trend value per 10 minutes. By thus displaying a plurality of kinds of information in one graph, it is possible to allow the user to visually recognize the plurality of kinds of information at a time. The plurality of kinds of information may be displayed distinguishably from each other, using solid lines and dashed lines. Also, a plurality of graphs may be generated and one graph may be made semitransparent and superimposed on the other graph(s). The form of the graph is not limited to the bar graph. It is also possible to employ a configuration in which various other graph forms can be selected.

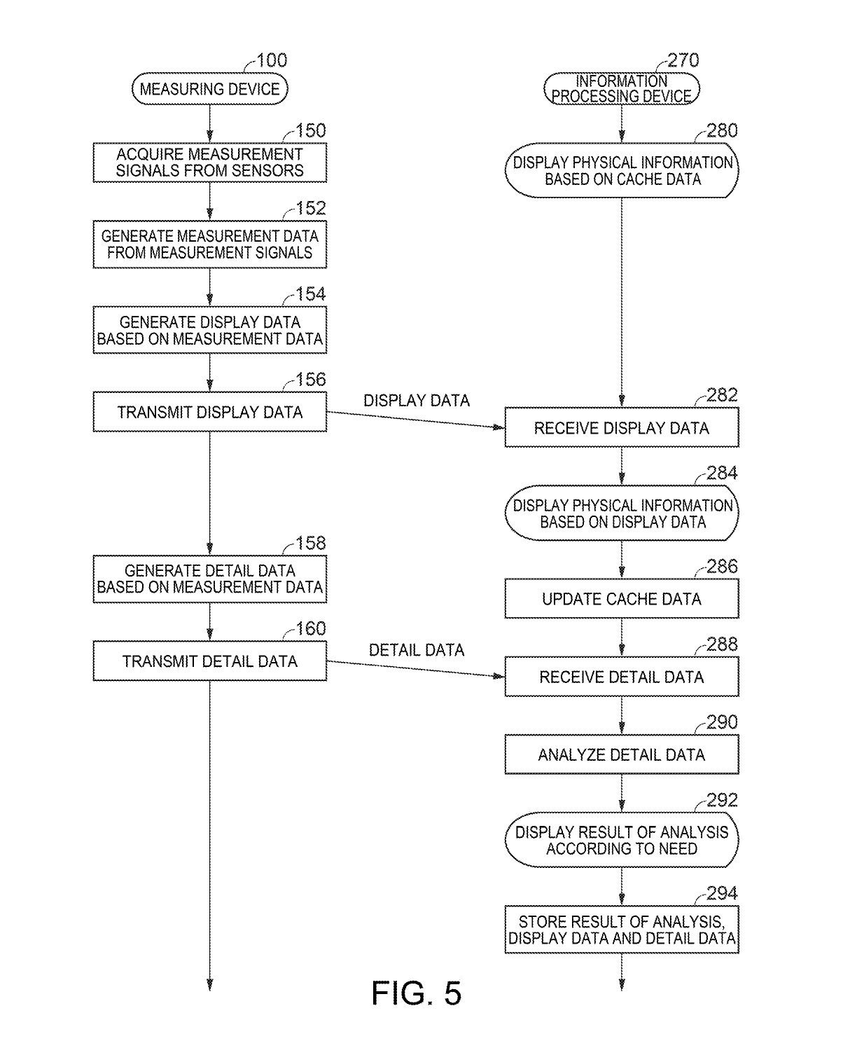

FIG. 5 is a flowchart showing the flow of processing in the measuring system 10. As this processing starts, first, the measuring device 100 acquires measurement signals outputted form the pulse wave sensor 112 and the acceleration sensor 114 (Step S150) and generates measurement data from the measurement signals (Step S152).

Next, the measuring device 100 generates display data on the basis of the measurement data (Step S154) and transmits the generated display data to the information processing device 270 (Step S156).

The information processing device 270 first displays physical information on the basis of cache data held therein (Step S280).

Subsequently, the information processing device 270 receives the display data (Step S282) and displays the physical information on the basis of the received display data (Step S284).

Next, the information processing device 270 updates the cache data on the basis of the received display data (Step S286).

Subsequently, the measuring device 100 generates detail data on the basis of the measurement data (Step S158), transmits the generated detail data to the information processing device 270 (Step S160), and ends the processing.

The information processing device 270 receives the detail data (Step S288) and analyzes the received detail data (Step S290).

Next, the information processing device 270 displays the result of the analysis according to need (Step S292), stores the result of the analysis, the display data and the detail data (Step S294), and ends the processing.

The embodiment has the following advantageous effects.

(1) When the measuring device 100 is started up and the measuring unit 110 starts measurement, measurement data is compressed to generate display data, and the display data is transmitted to the information terminal 200, where a simple graph is displayed then. Subsequently, the measurement data, without being compressed, is transmitted to the information terminal 200, where a detailed graph is displayed. Therefore, the user can visually recognize the transition of the measurement data from the graphs without waiting for the end of the transmission of the measurement data.

(2) Since the uncompressed measurement data is transmitted to the information terminal 200 in the background, delays in various functions of the information terminal 200 due to data reception can be avoided.

While the embodiment of the invention is described above with reference to the drawings, the specific configurations in the embodiment are not limiting and design changes and the like can be made without departing from the scope of the invention.

For example, each data shown in the database structure 20 of the display data is not limited to this example. A plurality of database structures other than the database structure 20 may be defined in advance, and at startup, the information terminal 200 may notify the measuring device 100 of the information of the database structure to be used. Also, the database structure 20 is not limited to the information for generating a graph image and may include, for example, necessary data for data analysis based on compressed information, or data to be transmitted to another device via the network 30 before detail data is received, or the like.

The device which carries out the above technique may be implemented by a single device or may be implemented by a combination of a plurality of devices, and may include various forms of embodiment.

What is claimed is:

1. A physical information measuring device comprising:
a measuring unit which measures physical information about a body;
a measurement data generator which generates measurement data on the basis of the physical information;
a display data generator which generates display data to be displayed at an external device, on the basis of the measurement data;
a transmitter which transmits the measurement data and the display data to the external device; and
a controller which performs control to transmit the display data preferentially over the measurement data.

2. The physical information measuring device according to claim 1, wherein
the display data is made up of time information and the measurement data corresponding to the time information.

3. The physical information measuring device according to claim 1, wherein
the measurement data includes a pulse rate and an action trend value indicating an action of the body.

4. The physical information measuring device according to claim 1, wherein
the display data generator generates the display data by calculating an average value or a representative value of the measurement data corresponding to a plurality of periods.

5. The physical information measuring device according to claim 1, wherein
the controller causes the display data to be transmitted to the external device and causes the measurement data to be transmitted to the external device after the transmission of the display data is finished.

6. The physical information measuring device according to claim 1, further comprising:
a first memory which stores the measurement data; and
a second memory which stores the display data.

7. The physical information measuring device according to claim 1, wherein
the measuring unit includes at least one of a pulse wave sensor and an acceleration sensor.

8. A physical information measuring system in which a measuring device and an information processing device are connected in such a way as to be able to communicate with each other, wherein
the measuring device comprises:
a measuring unit which measures physical information about a body;
a measurement data generator which generates measurement data on the basis of the physical information;
a display data generator which generates display data to be displayed at the information processing device, on the basis of the measurement data;
a transmitter which transmits the measurement data and the display data to the information processing device; and
a controller which performs control to transmit the display data preferentially over the measurement data, and
the information processing device comprises:
a receiver which receives the measurement data and the display data; and
a display controller which causes a display to display an image generated on the basis of the display data that is received.

9. The physical information measuring system according to claim 8, wherein
the display controller performs processing of updating the image on the basis of the measurement data when the reception of the measurement data is completed.

10. The physical information measuring system according to claim 8, wherein
the display controller changes a display form of at least a part of the image when the reception of the measurement data is completed.

11. The physical information measuring system according to claim 10, wherein
the change in the display form includes changing a display density in at least a part of the image.

12. The physical information measuring system according to claim 8, wherein
the information processing device includes an operation device which accepts instruction information to the image, and
the display controller performs change processing on the image on the basis of a signal from the operation device.

13. The physical information measuring system according to claim 12, wherein
the change processing on the image includes change processing on a display period and type change processing on the measurement data to be displayed.

14. The physical information measuring system according to claim 8, wherein
the display controller generates an icon indicating a receiving status of the measurement data and causes the display to display the icon.

15. The physical information measuring system according to claim 8, wherein
the information processing device includes an analyzer which analyzes the measurement data, and
the analyzer generates analysis data including at least one of depth of sleep, variation in heart rate, and physical strength index, on the basis of the measurement data.

16. The physical information measuring system according to claim 15, wherein
the display controller causes the display to display the analysis data in association with the image when the analysis data is acquired.

17. The physical information measuring system according to claim 8, wherein
the information processing device includes a memory which stores the measurement data, the display data, and the analysis data.

18. A data processing method comprising:
measuring physical information about a body;
generating measurement data on the basis of the physical information;
generating display data to be displayed at an external device, on the basis of the measurement data; and
transmitting the display data to the external device, and transmitting the measurement data after the transmission of the display data is finished.
